(19) United States
(12) Patent Application Publication
(10) Pub. No.: US 2009/0041205 A1
(43) Pub. Date: Feb. 12, 2009

(54) Methods, systems, and computer program products for detecting and mitigating ping call events in a communications network

(75) Inventors: Travis E. Russell, Clayton, NC (US); Peter J. Marsico, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: Tekelec

(21) Appl. No.: 11/903,505

(22) Filed: Sep. 21, 2007

Related U.S. Application Data
(60) Provisional application No. 60/964,334, filed on Aug. 10, 2007.

(51) Int. Cl. H04M 3/22

(52) U.S. Cl. 379/35

(57) ABSTRACT

Methods, systems, and computer program products for detecting and mitigating a ping call event in a communications system is described. In one embodiment, the method includes receiving a plurality of call signaling messages. The plurality of call signaling messages are analyzed and a determination is made as to whether at least a portion of the plurality of call signaling messages indicates a ping call event. In response to determining that the at least a plurality of call signaling messages indicates a ping call event, a mitigating action is performed.

### RELATED APPLICATIONS

The present application claims the benefit of U.S. Provisional Patent Application Ser. No. 60/964,334, filed Aug. 10, 2007; the disclosure of which is incorporated herein by reference in its entirety.

### TECHNICAL FIELD

The subject matter described herein relates to the monitoring of ping calls and preventing fraudulent activities within a communications network. More particularly, the subject matter described herein relates to methods, systems, and computer program products for detecting and mitigating ping call events in a communications network.

### BACKGROUND

Presently, fraudsters and other unscrupulous parties are taking advantage of inherencies existing in telecommunications networks to conduct fraudulent or unethical activities. Specifically, some fraudsters are manipulating subscribers' caller ID displays and missed call logs by using ping calls (i.e., calls that are quickly released upon connecting with a called party terminal) to compel unsuspecting victims to call back. In one scenario, ping calls are used to inflate revenues for premium rate services (PRS). For example, a fraudster may use one or more automatic dialers positioned behind a private branch exchange (PBX) to transmit multiple call signaling messages into a particular geographic area, wherein each call is directed to a different called party. However, before a call can be answered by a recipient, the call is released by the PBX and a calling party number is captured by the caller ID display or missed call log.

In these ping call event scenarios, the captured calling party number is typically a “spoofed” calling party number. Namely, the fraudster replaces the Automatic Number Identification (ANI) number (i.e., the original calling party number) for each call with some other number that does not raise suspicion on the called party's caller ID display or log of missed calls. However, the spoofed number may be associated with a PRS call center or operator. In many instances, this results in the called party dialing the captured ANI number back after realizing a call has been missed. The return call is then routed to a PRS operator. Although the caller (i.e., the original called party) normally hangs up immediately after realizing a PRS call center has been reached, the call has already been made, (i.e., the connection to the PRS operator has been completed) and charges have been assessed. In many instances, the rates for connecting the call are significant and may be assessed to the unsuspecting called victim. In other cases, the connecting operator may be held responsible for paying the PRS operators for these calls. Revenues collected by PRS operators obtained in this unethical manner can amount to millions of dollars per year.

In a similar scenario, ping calls are used by telemarketers in the United States as a means for bypassing the “Do Not Call” registry. The process for attracting an unsuspecting victim is the same as described above. Namely, one or more automatic dialers are used to launch hundreds or thousands of calls into the network that are released after sufficient time for false caller ID information to be displayed. The unsuspecting called parties then return the call and reach a telemarketer operator. No immediate revenue loss is associated with this scenario, other than those associated with possible congestion at the switches and trunks.

Accordingly, there exists a need for methods, systems, and computer program products for detecting and mitigating ping call events in a communications network.

### SUMMARY

According to one aspect, the subject matter described herein comprises methods, systems, and computer program products for detecting and mitigating a ping call event in a communications system. One method includes receiving a plurality of call signaling messages. The plurality of call signaling messages are analyzed and a determination is made as to whether at least a portion of the plurality of call signaling messages indicates a ping call event. In response to determining that the at least a plurality of call signaling messages indicates a ping call event, a mitigating action is performed.

The subject matter described herein for detecting and mitigating a ping call events may be implemented using a computer program product comprising computer executable instructions embodied in a computer readable medium that are executed by a computer processor. Exemplary computer readable media suitable for implementing the subject matter described herein includes disk memory devices, programmable logic devices, application specific integrated circuits, and downloadable electrical signals. In addition, a computer readable medium that implements the subject matter described herein may be distributed across multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a network diagram illustrating an exemplary call flow for a ping call event in an exemplary communications network;

FIG. 2 is a network diagram illustrating a call flow for a victim returning a call to a spoofed number in response to a ping call;

FIG. 3 is a network diagram illustrating a probe-based ping call detection system according to an embodiment of the subject matter described herein;

FIG. 4 is a block diagram illustrating exemplary components of a ping call detection system according to an embodiment of the subject matter described herein;

FIG. 5 is a block diagram of a signal transfer point containing an integrated ping call detection system module according to an embodiment of the subject matter described herein;

FIG. 6 is a flow chart illustrating exemplary steps for detecting and mitigating ping call events according to an embodiment of the subject matter described herein;

FIG. 7 is a network diagram illustrating the use of a ping call detection system to actively block ping call events according to an embodiment of the subject matter described herein;

FIG. 8 is a network diagram illustrating the use of a ping call detection system to redirect responses to ping calls to a network operations center according to an embodiment of the subject matter described herein; and

FIG. 9 is a network diagram illustrating an exemplary SIP based call flow for a ping call event in an exemplary communications network.

### DETAILED DESCRIPTION

The present subject matter relates to systems, methods, and computer program products for detecting and mitigating ping call events in a communications network. In order to better understand the present subject matter, an explanation regarding the manner in which a communications network can be exploited using a ping call event is presented below. As used herein, a ping call event is characterized as a large volume of calls placed into the network by a fraudster or telemarketer using one or more automated dialers positioned behind a private branch exchange (PBX). The calls are called “ping calls” because they are released before the called party is able answer.

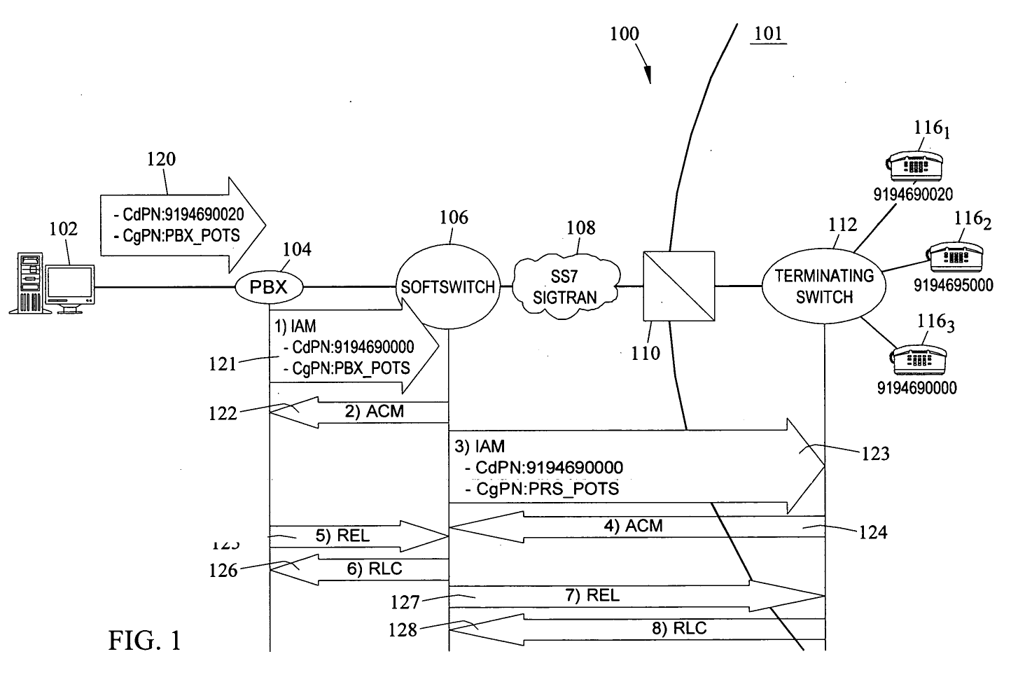

FIG. 1 illustrates a plurality of messages traversing an exemplary telecommunications network 100 during a ping call event. Referring to FIG. 1, an automated dialer 102 is positioned behind a private PBX 104 and is configured to generate a large volume of calls intended for unsuspecting subscribers 116_{1 . . . 3} in customer network 101. Signal 120 depicts an exemplary call initiation signal intended to initiate a ping call to a subscriber 116₁ associated with the telephone number 9194690020. As depicted in FIG. 1, ping calls may be directed to wireline subscribers 116_{1 . . . 3} serviced by a public switched telephone network (PSTN) end office, i.e., terminating switch 112. Although only three wireline subscribers are shown in FIG. 1, any number of wireline subscribers (as well as wireless subscribers) may be supported without departing from the scope of the present subject matter.

Upon receiving call initiation signal 120, PBX 104 generates a call signaling message (e.g., IAM message 121) addressed to the called party number (CdPN) associated with targeted subscriber 116₁ and containing a calling party number (CgPN) associated with PBX 104. Call signaling message 121 is then routed to an intermediate switching point that is complicit with the fraudulent ping call event scheme. In FIG. 1, the intermediate switching point is a softswitch 106. Softswitch 106 may receive and terminate call signaling messages, such as IAM message 121, in order to establish a first leg (e.g., a bearer trunk/circuit between PBX 104 and softswitch 106) of the call. Softswitch 106 subsequently responds to PBX 104 with an address complete message (ACM) message 122. Softswitch 106 then generates a new IAM message 123 which includes the same CdPN value contained in original message 121. However, softswitch 106 may be configured by a fraudster to include a different CgPN value (i.e., a “spoofed” CgPN) in message 123. The new CgPN address value may include a telephone number (e.g., POTS number, mobile number, etc.) that is associated with the fraudster's call center, interactive voice response (IVR) system, or any other designated number. Notably, the new number is not the true number of the originator, thereby ultimately making it difficult to identify the source of a ping call event.

After being modified with the spoofed CgPN, IAM message 123 is routed from softswitch 106 to the network (e.g., customer network 101) that supports the subscriber corresponding to the targeted CdPN (e.g., subscriber 116₁). In this example, IAM message 123 enters customer network 101 via gateway signal transfer point (STP) 110. Gateway STP 110 routes IAM message 123 to a terminating switch 112, which is responsible for serving targeted subscriber 116₁. Upon receiving IAM message 123, terminating switch 112 responds to softswitch 106 with an ACM message 124, and applies a ringtone to the line of subscriber 116₁.

At approximately the same time that target terminal 116 is alerted of the call, PBX 104 receives ACM message 122 from softswitch 106 and (in response to receiving ACM 122) waits for a short predefined period of time (e.g., 1 to 5 seconds) before generating and transmitting a release message 125. PBX 104 may be configured by the fraudster to send release message 125 to initiate the teardown of the call since there was never any intention for the ping call to be answered. Specifically, release message 125 is transmitted to softswitch 106, which then releases the reserved bearer trunk/circuit and responds to PBX 104 with a release complete (RLC) message 126. Softswitch 106 subsequently generates a release message 127, which is transmitted to terminating switch 112. Terminating switch 112 releases the reserved bearer trunk/circuit for that leg of the call and transmits its own RLC message 128 to softswitch 106 thereby ending the call. However, before the call is ended, the spoofed calling party number has already been captured by the called party's caller ID display or missed call log. The capture of the spoofed calling party number by the targeted subscriber is important since the fraudster relies on the targeted subscriber to ultimately notice the spoofed CgPN number as a missed call and to subsequently choose to call the spoofed CgPN. Although it is likely that most people do not return a call to an unfamiliar number, the fraudster is still able to deceive (i.e., “hook”) a considerable number of people due to the sheer number of ping calls made.

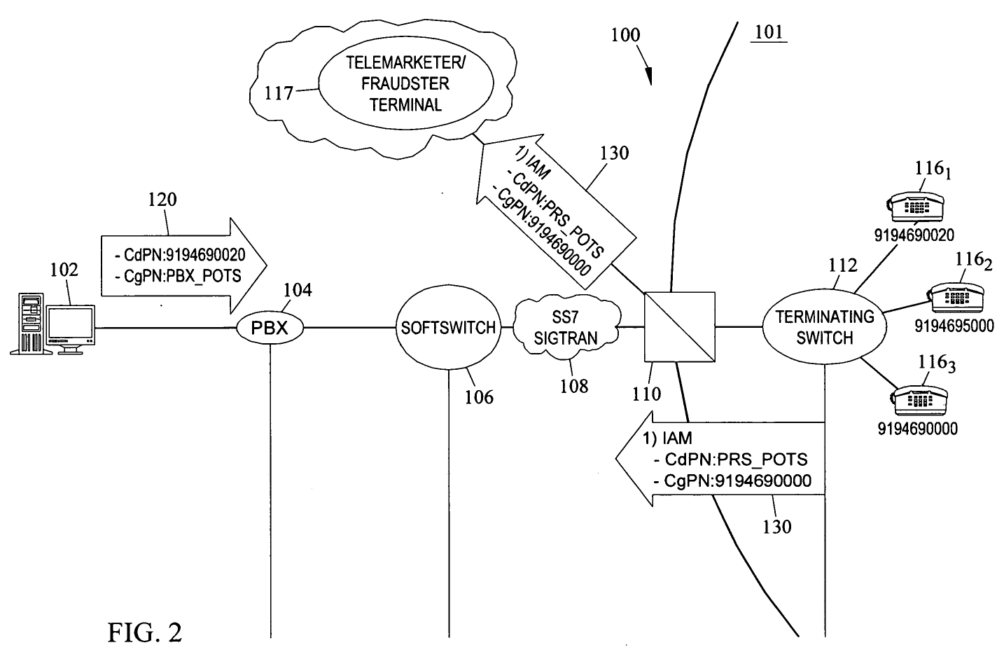

FIG. 2 depicts an exemplary “hooking” aspect of the fraudulent ping call event scheme that the present subject matter is intended to prevent. In this example, terminating switch 112 transmits IAM message 130 to the switching office associated with fraudster 117 through gateway STP 110 (after the calling subscriber initiates a call to the spoofed CgPN). STP 110 routes message 130 to the switching office associated with the spoofed CgPN number. In one embodiment, the spoofed CgPN is associated with a call center or terminal 117 operated by a telemarketer or fraudster. For example, the call may be routed to a Premium Rate Service (PRS) provided by an audiotext operator in Europe, Asia, or any other foreign location. When the call to the spoofed CgPN is returned, the subscriber is charged a large fee by the PRS as soon as the call is answered (i.e., cut-through) to terminal 117. Even if the calling subscriber promptly realizes the mistake and immediately hangs up, a sizeable charge is still incurred and must be paid by either the caller or a connecting operator.

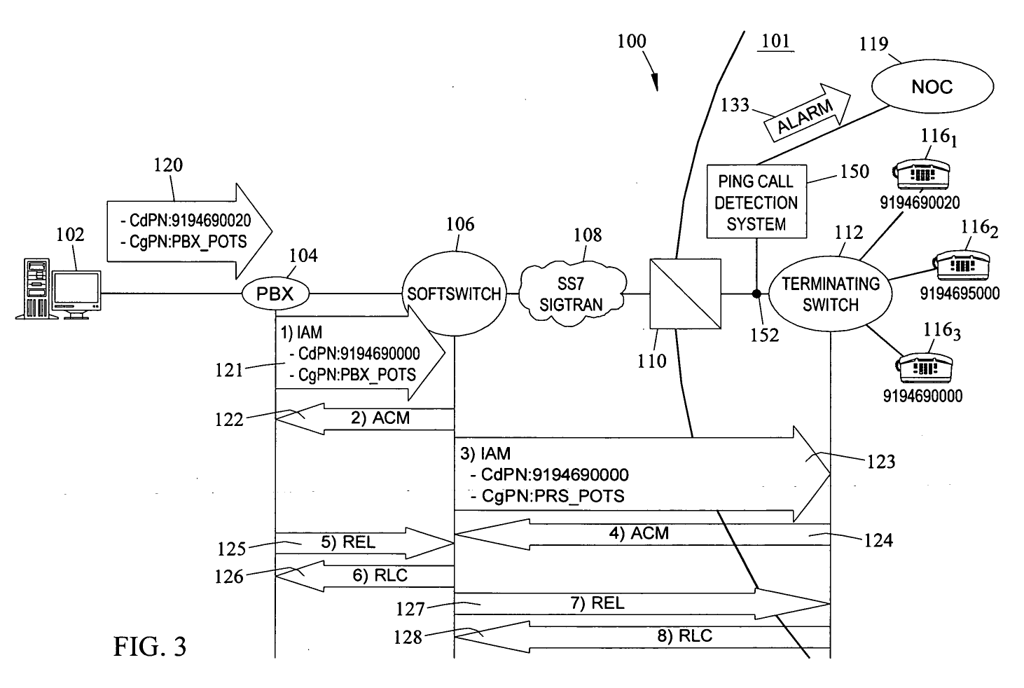

In order to detect and mitigate ping call events that deceive callers to contact fraudulent or telemarketing entities, the present subject matter includes a ping call detection system (PCDS). FIG. 3 depicts an exemplary PCDS 150 in customer network 101 as a stand-alone network component. In one embodiment, PCDS 150 is responsible for collecting signaling data that traverses customer network 101 for analysis of call characteristics that may indicate a ping call event. The collection of signaling data may be achieved by PCDS 150 through the use of one or more probes 152 positioned within customer network 101. For example, PCDS 150 may include at least one probe 152 placed on the signaling link that couples gateway STP 110 to terminating switch 112. Although only one probe, signaling link, terminating switch, and STP are shown in FIG. 3, PCDS 150 may use additional probes in conjunction with a plurality of signaling links, terminating switches, and STPs without departing from the scope of the present subject matter. In one embodiment, probe 152 transparently copies the traversing signaling data (e.g., the call signaling messages or signaling message parameters) and forwards the copied data to PCDS 150.

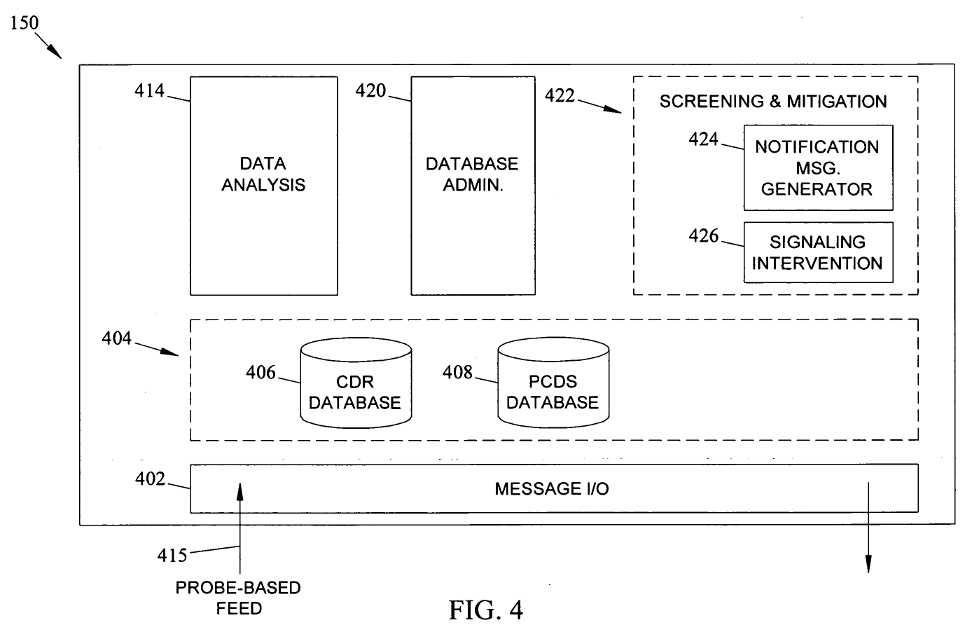

FIG. 4 is a block diagram of an exemplary ping call detection system 150. Referring to FIG. 4, PCDS 150 includes a message input/output interface module 402, a database structure 404, a data analysis module 414, a database administration module 420, and a ping call event screening and mitigation module 422. In one embodiment, message I/O interface module 402 may be adapted to receive call signaling data via a probe based feed 415. Ping call event screening and mitigation module 422 may include a processing component that utilizes filters for detecting certain ping call characteristics. In one embodiment, these filters are stored in database structure 404, which may include a call detail record (CDR) database 406 and a PCDS database 408. In one embodiment, CDR database 406 stores a plurality of CDRs generated based on call signaling messages, which may be analyzed by data analysis module 414 to detect a ping call event. PCDS database 408 stores various call characteristics and threshold values that are used to create a filter. Database administration module 420 may be used to modify any threshold based characteristics stored in PCDS database 408. If a ping call event is detected, ping call event screening and mitigation component 422 may use signaling intervention module 426 to perform a mitigating action such as modifying the calling party number in the ping call message. For example, module 426 may be used to replace the spoofed CgPN with the number of a customer network operator. The replacement of the spoofed CgPN with the CgPN of the network operator may trigger the subscriber to call the operator or an IVR server associated with the operator. The IVR server may play a message informing the called party of the original calling party number and warning the called party that the original calling party number may be associated with a toll charge. Alternatively, module 426 may be configured to block the call from reaching the intended called party. Ping call event screening and mitigation module 422 may also use a notification message generator module 424 to alert a customer network operator (e.g., NOC 119 in FIG. 3) of the detected ping call event, who may then perform any additional analysis and/or any mitigating action.

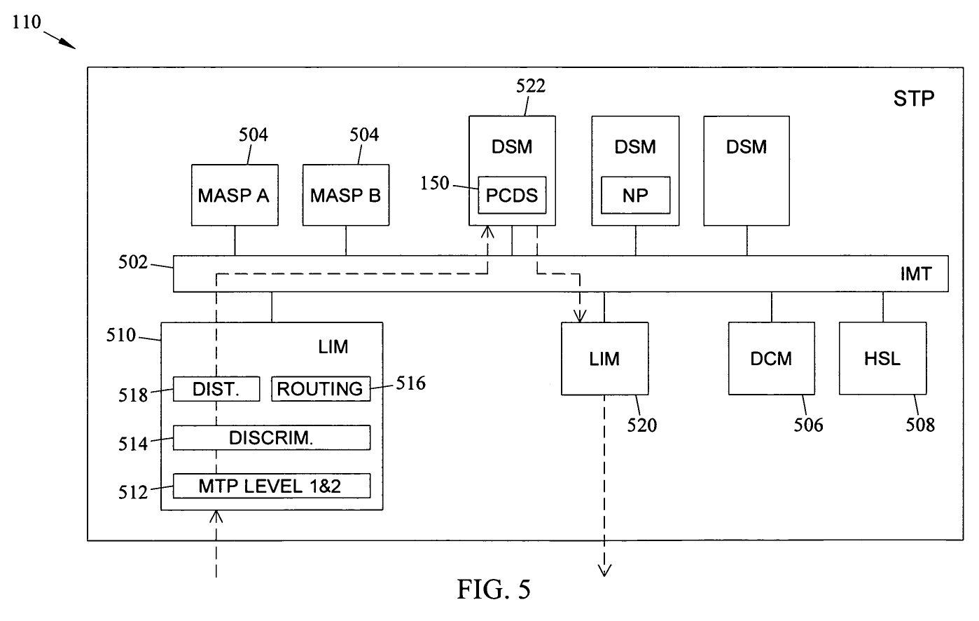

In an alternate embodiment, PCDS 150 may be implemented as a PCDS module within gateway STP 110 as shown in FIG. 5. FIG. 5 is a block diagram of an exemplary internal architecture of a signaling message routing node with an integrated PCDS 150 according to an embodiment of the subject matter described herein. Referring to FIG. 5, PCDS 150 may be located at STP 110, which includes an internal communications bus 502 that includes two counter-rotating serial rings. In one embodiment, a plurality of processing modules or cards may be coupled to bus 502. In FIG. 5, bus 502 may be coupled to one or more communications modules, such as a link interface module (LIM) 510, a data communications module (DCM) 506, a database service module (DSM) 522, a high speed link (HSL) 508 and the like. Each of these modules is physically connected to bus 502 such that signaling and other types of messages may be routed internally between active cards or modules. LIM 510 includes functionality for sending and receiving SS7 messages via an SS7 network. DCM 506 includes functionality for sending and receiving SS7 messages over IP signaling links. Similarly, HSL 508 includes functionality for sending and receiving messages over a high speed link.

When a signaling message is received by STP 110, the message may be processed by LIM 510, DCM 506, or HSL 508 depending on whether the message is sent over an SS7 link, an IP signaling link, or a high speed link. The message is passed up the communications protocol stack on the receiving communication module until it reaches the module's respective message distribution function, which forwards the call signaling message to DSM 522. In one embodiment, at least one DSM module 522 in STP 110 is equipped with a PCDS module. In one embodiment, the PCDS module functions in a similar manner to the PCDS depicted and described in FIG. 4. Notably, instead of being equipped with probe-based feed 415, PCDS module 150 (in FIG. 5) receives call signaling messages from DSM, LIM, and HSL modules (which are respectively coupled to a signaling link entering STP 110). That is, in one implementation, call signaling messages received by LIM 510 or 520, and DCM 506, or HSL 508 may be screened at the receiving module and identified as candidates for PCDS processing. For example, ISUP messages or SIP messages associated with call setup and teardown may be identified as PCDS screening candidates and forwarded to PCDS 150 for processing. In an alternate implementation, LIM 510, LIM 520, DCM 506, and HSL 508 may each include a message copy function that copies all received signaling messages and sends the copies to PCDS 150 for screening or that selectively copies candidate messages for PCDS screening and sends the candidates to PCDS 150.

In addition to collecting signaling data, PCDS 150 (either as a stand-alone network component or integrated in STP 110) may be responsible for analyzing the received call signaling data. In one embodiment, PCDS 150 is configured with at least one filter that is used to detect certain call characteristics that may be indicative of a ping call event. For example, an exemplary ping call event may be characterized as including a large volume of inbound calls originated by one source (or very few sources) and terminating at plural sources. Similarly, the calls associated with the ping call event are may be characterized as having been released by the originator after a short duration (e.g., 1-5 seconds). The ping call event may also cause trunks and/or routes in customer network 101 to reach a state of congestion.

These characteristics, or key parameters, may be used as criteria by a PCDS filter to objectively detect a ping call event. In one embodiment, a filter is generated by quantifying one or more characteristics with a respective threshold. For example, a threshold including a predefined number of inbound calls from a single source over a certain period of time (e.g., 20 calls over 60 seconds from the same CgPN) may be used as a threshold component for a filter. This filter component may be used to detect calls placed in a rapid succession, as one might expect from an automatic machine dialer. Similarly, one filter threshold component may utilize an answer seizure ratio (ASR) that monitors the number of attempted calls that are ultimately completed. Specifically, ASR includes the ratio of the number of attempted calls to the number of calls that are picked up by the called party. Since a ping call is intended to leave a spoofed CgPN on a caller ID display (or missed called log) before the call is answered, a high ASR ratio (e.g., a 50:1 ratio) may be indicative of a ping call event. Likewise, a filter component may include a threshold that detects a high quantity of short length calls released by the originator (e.g., more than 50 calls lasting up to 5 seconds and are terminated by the calling party). Once a filter is created, it may be applied by PCDS 150 to any received call signaling message stream or copy thereof. In one embodiment, if one or more of the filter threshold components are exceeded (as configured by a network operator), then an indication is given that a potential ping call event may be detected.

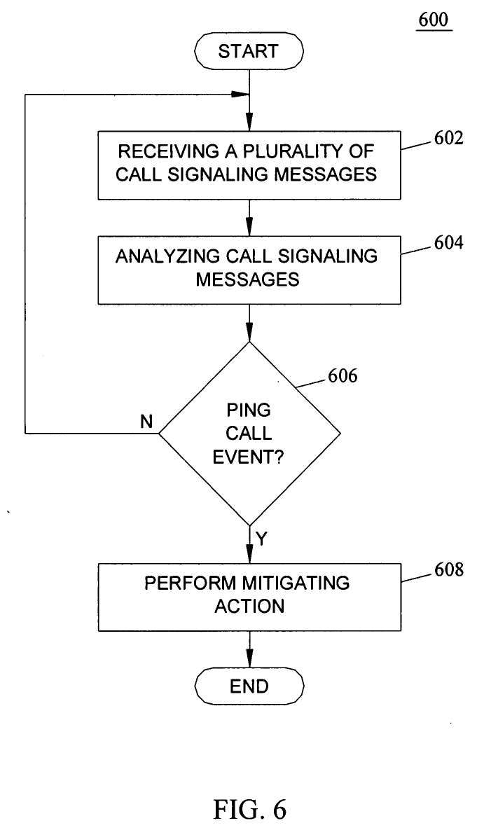

FIG. 6 illustrates a flow chart of an exemplary method 600 for detecting and mitigating a ping call event according to an embodiment of the subject matter described above. In one embodiment, method 600 may be executed by a processing unit, such as screening and mitigation module in PCDS 150 or a like computer processing device. In block 602, a plurality of call signaling messages is received. In one embodiment, PCDS 150 utilizes at least one probe to capture call signaling messages from a signaling link connecting STP 110 and terminating switch 112. In an alternate embodiment, STP 110 is equipped with a PCDS module 150 that receives call signaling messages from a signaling link entering STP 110. More specifically, a communication module, such as LIM 510 receives call signaling messages from a signaling link and forwards the signaling messages to DSM 522.

In block 604, the call signaling messages are analyzed. In one embodiment, PCDS 150 utilizes a screening and mitigation module 422 to apply filters to the received call signaling messages. Specifically, screening and mitigation module 422 uses filters to determine various call characteristics.

In block 606, a determination is made as to whether a ping call event is detected. In one embodiment, data analysis module 414 analyzes the filter results to determine if a possible ping call event exists. For example, if a predefined number of filter thresholds are exceeded, then a possible ping call event is detected. If a possible ping call event exists, then method 600 continues to block 608. If a ping call event is not suspected, then method 600 loops back to block 602 to continue monitoring.

In block 608, a mitigating action is performed. In response to detecting a ping call event, PCDS 150 may perform a mitigation action. In one embodiment, PCDS 150 is configured to modify the calling party number of the signaling messages associated with the ping call event. For example, a network operator's phone number may be used to replace the spoofed CgPN. In an alternate embodiment, PCDS 150 is adapted to block the call by releasing call signaling messages associated with the detected ping call event so that the called party never receives the ping call. The method 600 then ends.

As mentioned above, PCDS 150 may be configured to perform a mitigating action such as generating an alarm, blocking calls, producing dashboards, and outputting reports. For example, when a ping call event occurs and is detected by PCDS 150, a network operator may receive an alarm at NOC 119 indicating the ping call event is occurring (in real-time). Upon receiving the alarm, the operator may analyze the filtered data to confirm the occurrence of the detected ping call event. The alarm may also identify the origin of the ping call event so that other mitigating actions may be performed.

In one embodiment, PCDS 150 may generate one or more dashboards to provide a network operator a real-time condition of the network as well as statistics on ping call events. The purpose of the dashboard is used to alert the security department that a ping call attack may be underway, but has not yet reached congestion points. In one embodiment, the dashboards measure the number of short duration calls within the network, and when the number of short duration calls reach a threshold level, the dashboards indicate this through a graphical indicator. In one embodiment, traffic level dashboards provide an overall graph of traffic levels across all inbound routes allowing the operator to monitor traffic levels as well as highlighting increases that appear to be anomalies. This proactive view of attacks alerts the operator that the network traffic flows are beginning to reach critical levels.

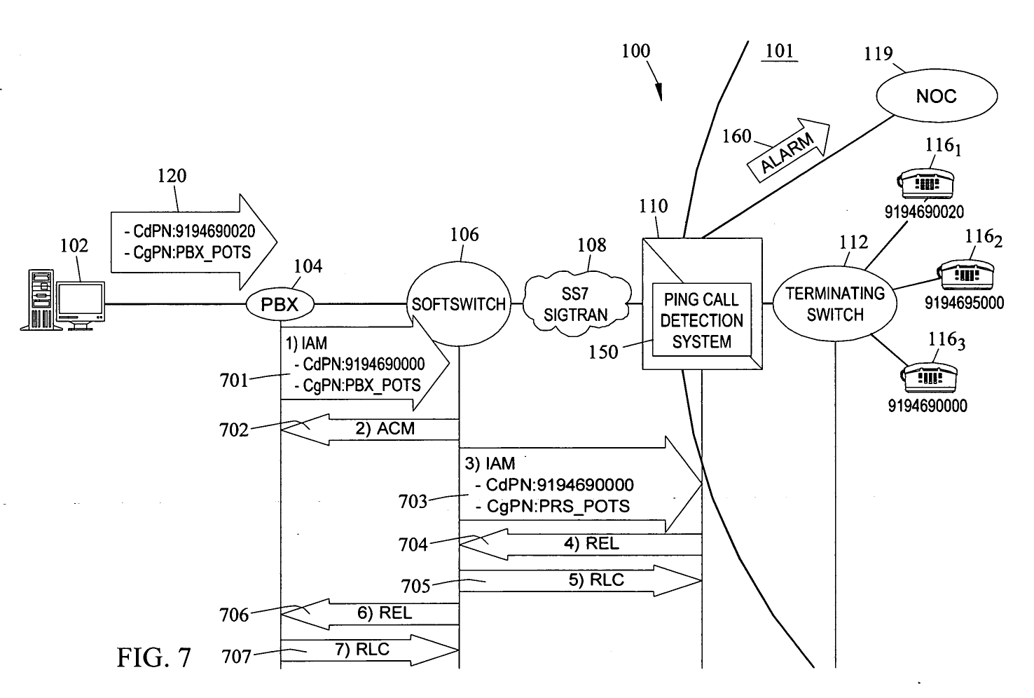

In one embodiment, PCDS 150 may be configured to block the ping calls upon detection. An exemplary gateway STP-based PCDS adapted for active blocking is depicted in FIG. 7. Although FIG. 7 depicts an embodiment where PCDS 150 is shown to reside within STP 110, it is appreciated that PCDS 150 may be positioned outside of STP 110 as a standalone network component without departing from the scope of the present subject matter. In one embodiment, PCDS 150 utilizes a call blacklist to block calls including a spoofed CgPN.

After a ping call event is initially suspected, PCDS 150 may generate an alarm message 160 to network operations center (NOC) 119. In response, NOC 119 establishes a call blacklist that may be implemented at STP 110 (or some other node in customer network 101). For example, any received call with a CgPN matching any one of the CgPN entries in the call blacklist is actively blocked. In one embodiment, the blocking action may include receiving and detecting a blacklisted IAM at STP 110 (e.g., receiving IAM message 703), discarding the IAM, and generating a release message (e.g., release message 704) back to the originating switch. The call blacklist may include any number of calling party numbers (e.g., PBX_PRS) so as to block a single CgPN or range of CgPN numbers that may be used by the fraudster. In another embodiment, a network operator or PCDS 150 may block all calls coming from an SS7 or IP network address associated with an originating/offending switch instead of using calling party numbers. This feature may be implemented at the gateway screening level of STP 110.

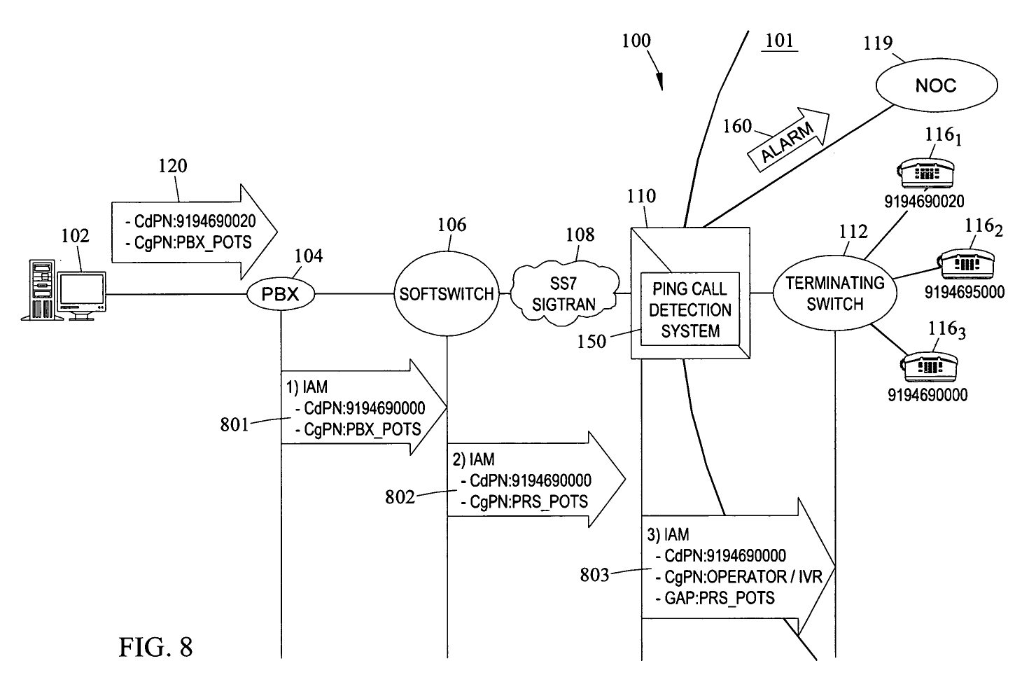

In one embodiment, PCDS 150 is adapted to modify IAM messages upon detecting a ping call event. An exemplary gateway STP-based PCDS adapted for calling party number modification is depicted in FIG. 8. For example, PCDS 150 may modify the CgPN address information contained in an intercepted IAM message 802 by inserting the phone number of a network operator or a network interactive voice response (IVR) system in the CgPN parameter of the IAM message. PCDS 150 may then place the original “spoofed” CgPN value in another parameter, such as a generic address parameter (GAP) or charge number ANI parameter in IAM message 803. IAM message 803 is then routed to the terminating switch and ultimately provided to called party 116.

Consequently, the “calling party number” captured by the targeted subscriber's telephone or caller ID unit is no longer the spoofed CgPN, but instead is a number associated with the network operator, a network call center, or a network operator controlled/authorized IVR. This is shown in IAM message 803, which includes a replacement CgPN (i.e., operator or IVR) and the spoofed CgPN (i.e., PRS-POTS) in the GAP field. Therefore, if the targeted subscriber is “hooked” and happens to return the call to the CgPN left on the caller ID display (or in the missed call log), a network operator or IVR service is reached instead. The network operator or authorized IVR service associated with customer network 101 may then bring the subscriber's attention to the suspicious nature of the call-back number that was replaced and confirm whether the subscriber wishes to proceed to contact the original calling party.

In yet another embodiment, PCDS 150 may identify a call attempt as a potential ping call, and subsequently re-direct the call to an intermediate network operator controlled IVR element. The IVR element is adapted to answer the call and confirm the validity of the calling party. For example, the IVR may answer the call and request that the calling party enter a digit sequence in order to continue call setup to the original called party. If the calling party (e.g., a ping call machine dialer) is unable to comply with the request, then the call may be interpreted as a ping call and an appropriate mitigating action may be taken by the network operator. If the calling party is able to comply with the validation request, then the IVR is adapted to continue call setup to the original called party.

In the examples illustrated above, PCDS 150 is configured as a probe-based system (FIG. 3) and an integrated STP-based system (FIG. 5). However, the subject matter described herein is not limited to those configurations. In an alternate implementation, PCDS 150 may be co-located with any signaling point that processes or routes signaling messages used to set up and release calls. For example, in a network that uses SIP for call setup, such as an IMS network, PCDS 150 may be co-located with a SIP signaling router without departing from the scope of the subject matter described herein.

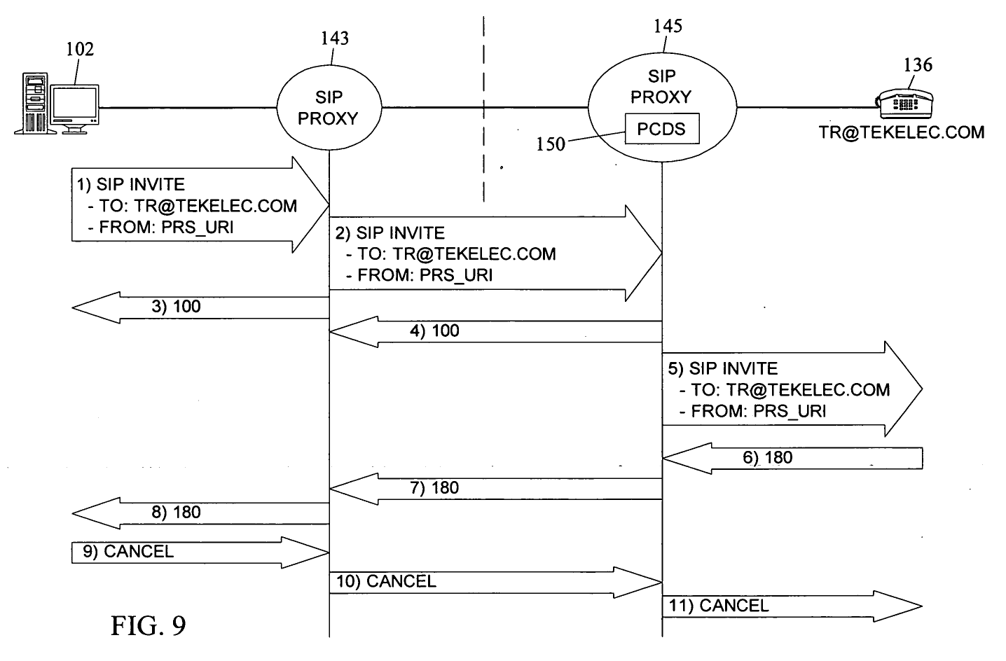

FIG. 9 illustrates how a ping call may be transmitted over an exemplary IMS network. Machine dialer 102 begins by transmitting a SIP INVITE message to SIP proxy 143. Notably, the SIP INVITE message includes a URI for call center 117 associated with the fraudster or telemarketer (e.g., the “calling party” address includes a PRS URI) instead of the calling party's URI. After receiving the SIP INVITE message, SIP proxy 143 then routes the message to at least one SIP proxy 415 that is used as a gateway by the called party's SIP call device 136. In an alternate embodiment, SIP proxy 143 may be configured by the fraudster to insert the PRS_URI in the SIP INVITE message as opposed to machine dialer 102. SIP proxy 143 similarly transmits a “100 message” that acknowledges the reception of the SIP INVITE message from machine dialer 102. Upon receiving the SIP INVITE message, SIP proxy 145 routes the message to SIP call device 136 and sends a “100 message” back to SIP proxy 143.

After receiving the SIP INVITE message (but before the called party answers), SIP call device 136 transmits a “180 message” (i.e., a “trying to contact” message) back to machine dialer 102 via SIP proxy 143 and SIP proxy 145. In response, machine dialer 102 sends a Cancel message (e.g., a release message) back to SIP call device 136 (via SIP proxy 143 and SIP proxy 145). Upon receiving the Cancel message, call device 136 releases the call. Like the aforementioned examples, the release action is typically executed prior to the called party answering the phone but after the spoofed calling party URI (e.g., PRS_URI) is captured by the caller ID function or missed call log associated with SIP call device 136.

In one embodiment, SIP proxy 145 may include PCDS 150, which is adapted to perform all SIP-based ping call event monitoring and mitigating functions. The SIP-based monitoring and mitigating functions are performed in a manner similar to the STP based ping call event monitoring and mitigating functions described above.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for detecting and mitigating a ping call event in a communications system, the method comprising:
receiving a plurality of call signaling messages;
analyzing the plurality of call signaling messages to determine whether at least a portion of the plurality of call signaling messages indicates a ping call event; and
in response to determining that the at least a plurality of call signaling messages indicates a ping call event, performing a mitigating action.

2. The method of claim 1 wherein receiving a plurality of call signaling messages comprises receiving copies of the plurality of call signaling messages.

3. The method of claim 1 wherein the ping call event is identified upon an answer seizure ratio (ASR) value exceeding a predefined ASR threshold level.

4. The method of claim 1 wherein the ping call event is identified upon receiving a number of call signaling messages with a same calling party number or group of calling party numbers that exceeds a predefined threshold level.

5. The method of claim 1 wherein the ping call event is identified upon receiving a number of call signaling messages for calls that are released within a predetermined time period by a same calling party number or group of calling party numbers that exceeds a predefined threshold level.

6. The method of claim 1 wherein performing a mitigating action comprises:
blocking call signaling messages associated with the ping call event.

7. The method of claim 1 wherein performing a mitigating action comprises:
replacing an original calling party number in a call signaling message of the ping call event with a number associated with a network operations center.

8. The method of claim 1 wherein performing a mitigating action comprises:
transmitting an alarm message to a network operations center.

9. The method of claim 1 wherein analyzing the plurality of call signaling messages includes utilizing an interactive voice response module to prompt an originator of at least one of the call signaling messages to provide a digit sequence to confirm the validity of the originator.

10. A ping call detection system (PCDS) for detecting and mitigating a ping call event, comprising:
a plurality of probes for copying a plurality of call signaling messages; and
a ping call event screening and mitigation module for analyzing the plurality of call signaling messages and determining whether at least a portion of the plurality of call signaling messages indicates a ping call event and for performing a mitigating action in response to determining that the at least a plurality of call signaling messages indicates a ping call event.

11. The system of claim 10 wherein the plurality of probes are adapted for copying of the call signaling messages from signaling links.

12. The system of claim 10 wherein the ping call event is identified upon an answer seizure ratio (ASR) value exceeding a predefined ASR threshold level.

13. The system of claim 10 wherein the ping call event screening and mitigating module identifies the ping call event upon receiving a number of call signaling messages with a same calling party number or group of calling party numbers that exceeds a predefined threshold level.

14. The system of claim 10 wherein the ping call event screening and mitigating module identifies the ping call event upon receiving a number of call signaling messages released for calls that are released within a time period by a same calling party number or group of calling party numbers that exceeds a predefined threshold level.

15. The system of claim 10 wherein the ping call event screening and mitigating module performs the mitigating action by blocking call signaling messages associated with the ping call event.

16. The system of claim 10 wherein the ping call event screening and mitigating module performs the mitigating action by replacing an original calling party number in a call signaling message of the ping call event with a number associated with a network operations center.

17. The system of claim 10 wherein the ping call event screening and mitigating module performs the mitigating action by transmitting an alarm message to a network operations center.

18. A ping call detection system (PCDS) for detecting and mitigating a ping call event, comprising:
a signaling node including:
a plurality of communications modules for receiving a plurality of call signaling messages; and
a ping call event screening and mitigation module for analyzing parameters from the plurality of call signaling messages received by the communications modules and determining whether at least a portion of the plurality of call signaling messages indicates a ping call event and for performing a mitigating action in response to determining that the at least a plurality of call signaling messages indicates a ping call event.

19. The system of claim 18 wherein the signaling node comprises a signaling message routing node.

20. The system of claim 19 wherein the signaling message routing node comprises a signal transfer point.

21. The system of claim 18 wherein the signaling message routing node comprises a SIP signaling router.

22. The system of claim 18 wherein the communications modules are adapted to copy the call signaling messages and send copies to the ping call event screening and mitigating module for ping call detection analysis.

23. The system of claim 18 wherein the ping call event screening and mitigating module is adapted to determine the presence of a ping call event based on call signaling messages that update plural calls from a single number or small group of numbers to a larger group of numbers within a time period.

24. The system of claim 18 wherein the ping call event screening and mitigating module is adapted to modify the calling party number displayed to the called party in a detected ping call.

25. A computer program product comprising computer executable instructions embodied in a computer readable medium for performing steps executed by a processor, comprising:
receiving a plurality of call signaling messages;
analyzing the plurality of call signaling messages to determine whether at least a portion of the plurality of call signaling messages indicates a ping call event; and
in response to determining that the at least a plurality of call signaling messages indicates a ping call event, performing a mitigating action.
